(19) United States
(12) Patent Application Publication
(10) Pub. No.: US 2003/0226708 A1
(43) Pub. Date: Dec. 11, 2003

(54) Personal vehicle including several features

(75) Inventors: Frank H. Hancock, Jackson, GA (US); Stephen C. Price, Barnesville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Snapper, Inc.

(21) Appl. No.: 10/392,271

(22) Filed: Mar. 18, 2003

Related U.S. Application Data
(60) Provisional application No. 60/365,763, filed on Mar. 18, 2002.

(51) Int. Cl. B62D 1/14

(52) U.S. Cl. 180/332

(57) ABSTRACT

The present invention relates generally to vehicles, and particularly relates to a “personal mobility vehicle”, which is typically used by a single rider on relatively flat terrain and can be powered by rechargeable batteries. The vehicle is configured to be “broken down” into smaller subapparatuses for purposes of transport. Also included is the use of a single elongate pivoting control bar, which can be grasped by an operator's fingertips while the operator keeps the operator's palms on main handle grips.

### CROSS REFERENCE TO RELATED APPLICATION

The present application claims the full benefit and priority of pending U.S. provisional patent application No. 60/365,763, filed Mar. 18, 2002, entitled “PERSONAL VEHICLE INCLUDING SEVERAL FEATURES”. The entire contents of said application are also incorporated by reference.

### TECHNICAL FIELD

The present invention relates generally to vehicles, and particularly relates to a “personal mobility vehicle”, which is typically used by a single rider on relatively flat terrain and is powered by rechargeable batteries.

### BACKGROUND OF THE INVENTION

Personal mobility vehicles are well known in the art. They have found a wide range of uses, such as in department stores and grocery stores for use by customers. They have also found uses as dedicated vehicles for users who may wish to transport them in their automobiles for use as desired. In the latter case, the portability of such units is a factor in their successful use. Improvements to same are always in demand, while at the same time understanding that costs provide practical limitations.

### SUMMARY OF THE INVENTION

Generally described, the present invention relates to a personal mobility vehicle which can be separated proximate its center, to allow for storage and/or transport.

The invention also relates to the use of a pivoting “finger-operated bar” for controlling forward and reverse movement.

Therefore, it is an object of the present invention to provide an improved personal mobility vehicle.

It is a further object of the present invention to provide a personal mobility vehicle that is easier to operate.

It is a further object of the present invention to provide a personal mobility vehicle that is simpler to operate.

It is a further object of the present invention to provide a personal mobility vehicle that is readily transportable.

It is a further object of the present invention to provide a personal mobility vehicle that includes improved control features.

It is a further object of the present invention to provide a personal mobility vehicle that is economical to manufacture.

Other objects, features, and advantages of the present invention will become apparent upon reading the following detailed description of the preferred embodiment of the invention when taken in conjunction with the drawing and the appended claims.

### BRIEF DESCRIPTION OF THE DRAWINGS

FIG. 1 is an overall pictorial view of the personal mobility vehicle apparatus 10 according to the present invention, viewed from the vehicle's left and front. This version does not include baskets, but another contemplated version.

FIG. 2 is a more isolated view of the rear main portion 40, showing the frame 41, tires 42, and the seat post 43. Front and rear harness wiring 61, 62 is also shown. One of two batteries 45 is shown in dotted line. A sleeve 52 and a pin member 56 are also shown at the front of the frame.

FIG. 3 is a view looking from behind and to the left of the front main portion 20, illustrating its front frame 21, the tube 51, and the front wiring harness 61 extending therethrough. A slotted flange 55 is also shown.

FIG. 4 illustrates the rear cover 46 in place, with the post 43 extending upwardly therethrough. The seat is not in place. A basket 70 is shown. This figure also shows the connection between the front and rear main portions 20, 40.

FIG. 5 (12) is a view of the steering handle assembly 30, which includes a handle bar 31 having opposing handles, and the one piece pivoting bar 100.

FIGS. 6A and 6B are illustrative views which show the pivoting bar 100 in an unpivoted and a pivoted position, respectively.

FIG. 7 is a view from underneath the handle bar 31. The two switches are shown with their commonly oriented triggers which contact the pivoting bar 100 when it is pivoted.

### DETAILED DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Elements List

Here follows an elements list:

| | |
|---|---|
| 10 | Personal Mobility Vehicle |
| 20 | Front Main Portion |
| 21 | Front Frame Portion |
| 22 | Front Wheels |
| 23 | Foot Platform (a.k.a. foot board) |
| 25 | Steering Column |
| 30 | Steering Handle Assembly |
| 31 | Handle Bar |
| 40 | Rear Main Portion |
| 41 | Rear Frame Portion |
| 42 | Rear Wheels |
| 43 | Seat Post |
| 44 | Seat |
| 45 | Batteries |
| 46 | Battery Cover |
| 50 | Detachable Medial Connection (a.k.a. middle connection) |
| 51 | Rearwardly-Extending Tube |
| 52 | Forwardly-Oriented Sleeve |
| 55 | Slotted Flange |
| 56 | Connecting/Limiting Pin |
| 61 | Front Wiring Harness |
| 62 | Rear Wiring Harness |
| 100 | One Piece Pivoting Bar (part of 30) |

General Construction

Generally described, the personal mobility vehicle apparatus 10 includes front and rear (a.k.a. “back”) main portions 20, 40, joined together by a pivotable, yet detachable, connection therebetween. This allows the apparatus to be “broken down” such that the front main portion 20 is separate from the rear main portion 40.

The front main portion 20 includes a front frame member 21, a pair of front wheels 22, a foot board 23, a steering column 25, and a steering handle assembly 30.

The rear main portion subapparatus 40 includes a rear frame portion 41, a pair of rear wheels 42, a seat post 43, a seat 44, batteries 45, and a battery cover 46.

General Operation

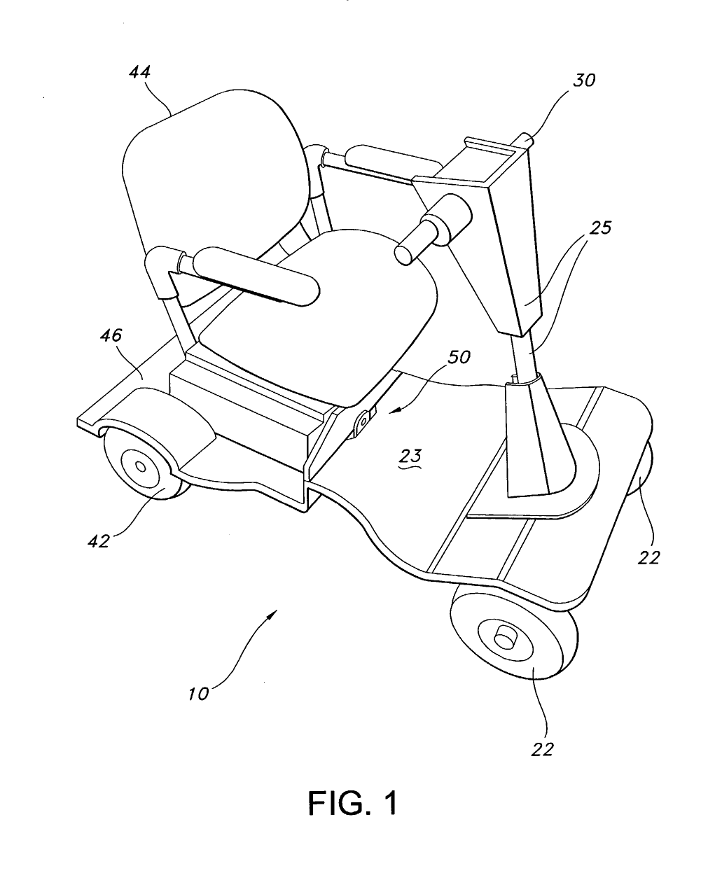

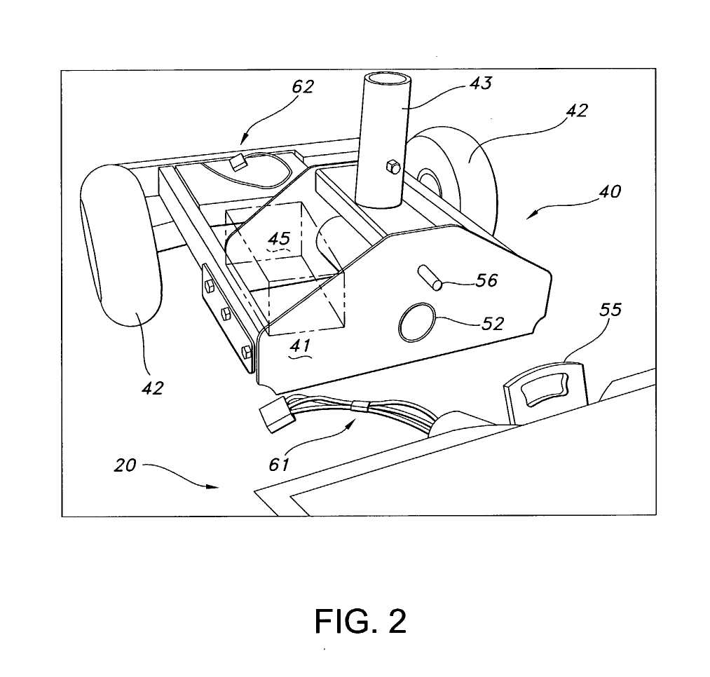

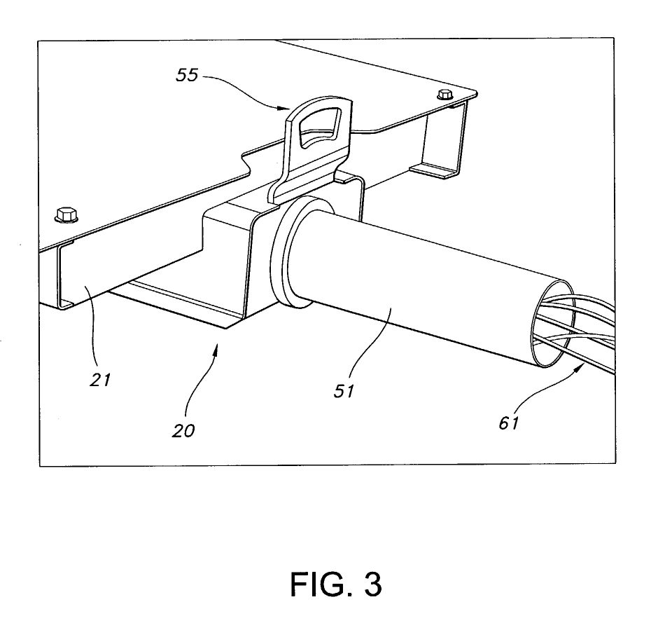

The apparatus 10 (see FIG. 1) is configured to transport a human operator (not shown) sitting on the seat 44 and operating the steering handle assembly 30 with the operator's hands. When the apparatus is desired to be transferred from one location to another, it can be “broken down” by use of a medial connection, which allows for the front main portion 20 to be temporarily separated from the rear main portion 40 by use of a medial connection 50 and thus transported (see generally FIGS. 2, 3 and 4). This can be further broken down by detachment of the seat 44, the steering handle assembly 30, and the batteries 45.

Various Details on Apparatus 10

As noted above, the front main portion 20 includes a front frame member 21, a pair of front wheels 22, a foot board 23, a steering column 25, and a steering handle assembly 30. The front frame member 21 is for supporting the various elements of the front main portion 20. The pair of front wheels 22 are steerable by use of the steering handle assembly 30. The foot board 23 is configured to support the weight of the user as needed. The steering column 25 supports the steering handle 30, but can be broken down as to separate the handle assembly 30 from the front main portion for transport.

The rear subapparatus 40 includes a rear frame portion 41, a pair of rear wheels 42, a seat post 43, a seat 44, batteries 45, and a battery cover 45. The rear frame portion 41 is for support. The seat post 43 supports the seat 44 which is used to support the operator but allows the seat to be detached for the sake of transport. The removable batteries 45 are concealed by a removable battery cover 46. The batteries 45 are configured to drive a drive motor (not shown) which is operably associated with the rear wheels 42 of the rear subapparatus 40.

The Medial Connection 50

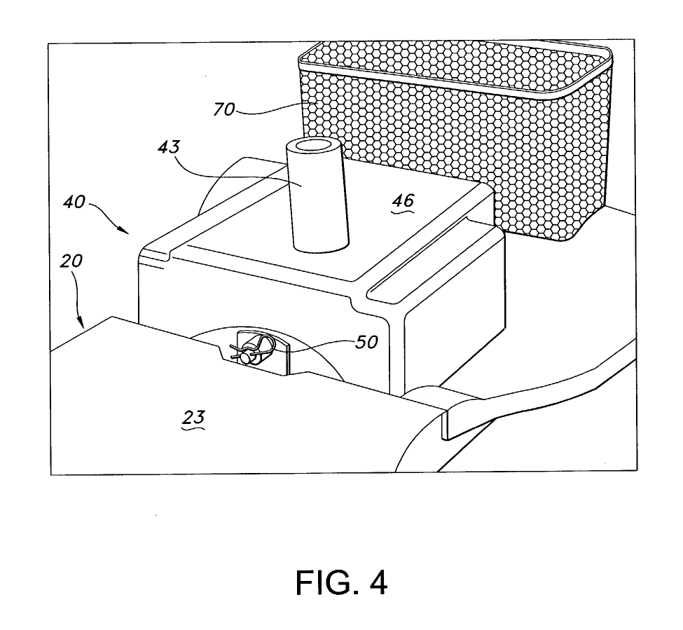

The front main portion 20 is pivotably and detachably connected relative to the rear main portion 40 by use of a medial connection subapparatus 50, which is comprised of a tube 51 and a tube/accepting sleeve 52 (see FIGS. 1, 4). This allows for a detachable connection which also allows for a limited pivoting action which is along an axis which is parallel to the longitudinal (front to back) axis of the vehicle. This limited pivoting action is desirable when the vehicle is operating on uneven ground.

The tube 51 is substantially rigid, and is substantially rigidly attached relative to the rear frame portion 41 of the front subapparatus 20. The tube 51 is hollow and defines an elongate interior cavity, having openings on either end of the tube. Wiring passes through this elongate cavity as discussed later.

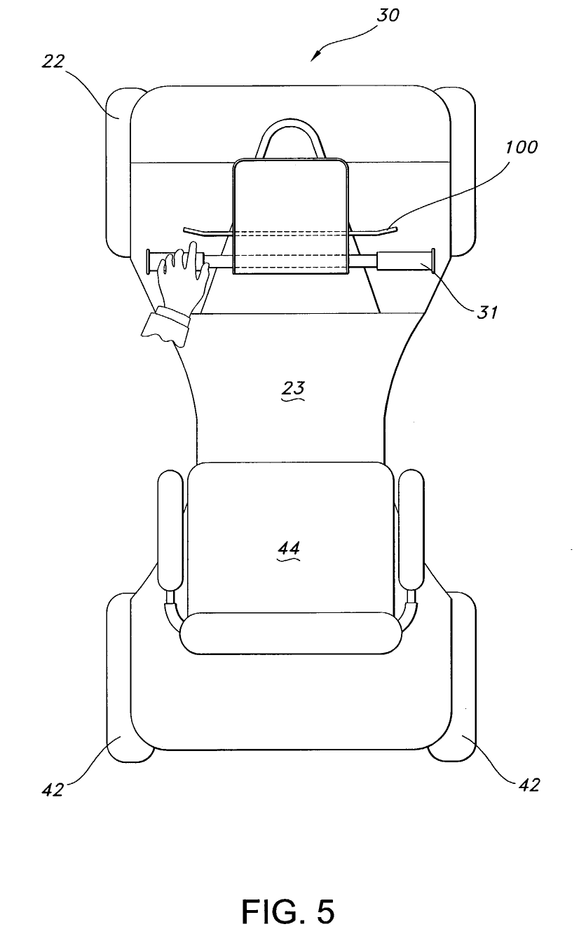

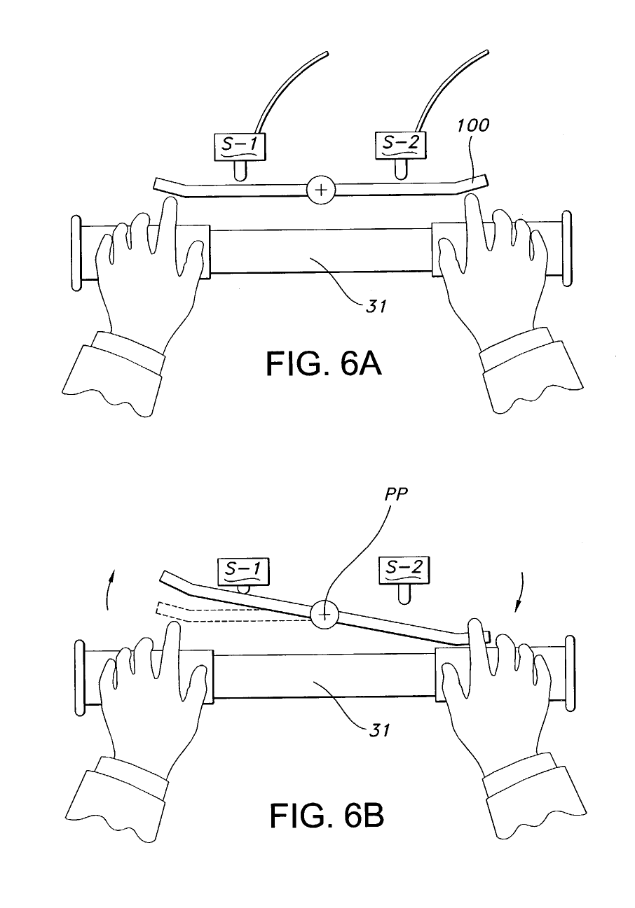

The tube-accepting sleeve 52 is mounted within the frame portion 41 of the rear subapparatus 40 as shown in FIGS. 5 and 6.

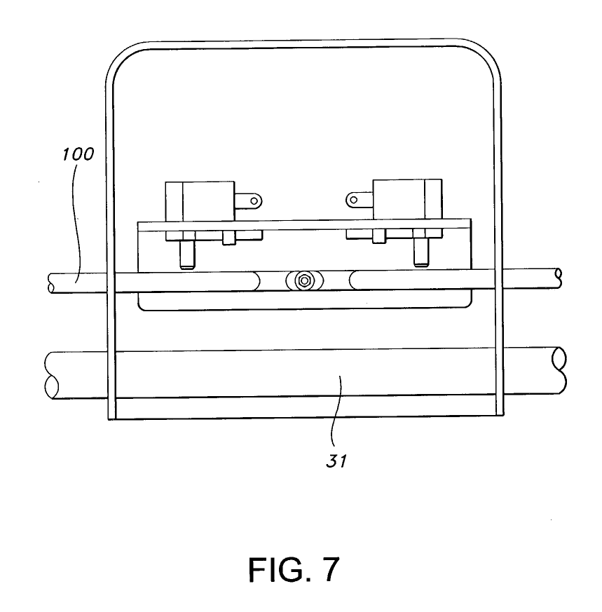

The limiting feature of the detachable medial connection 50 is provided by a pin 56 which extends forwardly from the rear subapparatus 40, and which fits within a slot defined by a slotted flange member 55 which extends upwardly from the rear of the front subapparatus 20 (see FIG. 7). As may be understood, when the tube 51 is inserted into the sleeve 52, the pin 56 is aligned such that it fits within the slot of the slotted flange member 55. When the medial connection is engaged, the pin 56 is allowed to move within the sleeve, but it is limited to the ends of the slot.

As shown particularly in FIG. 4, the pin 56 also combines with the slotted sleeve member 55, along with a spring pin and a plurality of flat washers in order to retain the tube/sleeve connection described above. This is done by placing the pin 56 in the slot of the flange 55, placing a suitable number of flat washers on the pin 56 for spacing purposes, and subsequently placing the spring pin in place on the end of the pin 56.

The tube 51 and the sleeve 52 are both hollow, which allows for wiring or other elongate members to extend therethrough. Wiring generally designated as front wiring harness 61 (in the front portion) and rear harness 62 (in the rear portion) is used within the present configuration, with suitable connections, which allows for a wiring harness in the rear apparatus 40 to be electrically connected to the wiring harness in the front subapparatus 20. However, the detachable relationship between the two harnesses allows for the apparatus to be detached at its detachable (pivoting) medial connection, such that it can be more easily stored. See FIG. 5 for the designation of elements 61, 62.

The Pivoting Control Bar (see FIGS. 12-19)

The steering handle assembly 30 includes a single pivoting bar 100 that extends substantially parallel to the longitudinal axis of a handlebar set. The pivoting bar 100 is pivotably mounted about an axis which allows its opposing ends to be selectively grasped, squeezed, and moved towards its associated handle grip. The action is much like grasping the clutch and brake handles on a typical motorcycle, except that in this situation the left and right ends of the bar 100 are coupled together and are not independent as is the case with a typical motorcycle. If the left hand grips and “squeezes” the left end of the pivoting bar 100 towards the left main handle, the right end of the pivoting bar 100 moves away from its associated main handle, and vice versa.

Two switches S1, S2, are associated with the pivoting bar 100. Depending on which end of the pivoting bar 100 is squeezed towards its associated handle grip, one or the other (but not both) of the two switches is depressed and activated.

FIG. 5 shows an example vehicle, which is a small electric “personal mobility” vehicle that might be used in a grocery store. A user would sit on the seat and manipulate the handle bar 31 left and right to turn the vehicle left and right while moving forward.

It should be understood that the present invention includes the use of a substantially integral “handle bar” 31 which is elongate and includes two handle grip portions, each of which are configured to be gripped by a corresponding hand of a user for steering or other control. However, other handle configurations could be used in conjunction with the pivoting bar 100.

Referring now also to FIGS. 6A and 6B, the one piece pivoting bar 100 is pivotably attached relative to the remainder of the handlebar assembly about a pivot point PP being along an axis which is perpendicular to the handles, and substantially vertical. FIGS. 6A and 6B are line drawings illustrating the operator's view of the configuration. FIG. 6A shows the pivoting bar not pivoted. FIG. 6B shows it pivoted clockwise by virtue of being squeezed towards it associated handle by virtue of the right hand of the user. This depresses one switch S1 (the left one). It may be understood that the pivoting bar could be pivoted counter-clockwise by virtue of being squeezed towards its associated handle by virtue of the left hand of the user. This would depress the right switch S2.

The two switches S1, S2 could be used to control forward and backward movement of the electrically powered vehicle. As an example, squeezing with the right hand could cause activation of switch S1, causing forward movement whereas squeezing with the left hand could cause activation of switch S2, causing rearward movement, or vice versa.

Miscellaneous

As shown in FIG. 4, a basket 70 can be attached to the front and/or back or the apparatus 10 to provide storage or other suitable use.

Conclusion

Therefore it may be seen that present invention provides a “personal mobility vehicle”, which is typically used by a single rider on relatively flat terrain and is powered by rechargeable batteries. The vehicle is configured to be “broken down” into smaller subapparatuses for purposes of transport. Also included is the use of a single elongate pivoting control bar, which can be grasped by an operator's fingertips while the operator keeps the operator's palms on main handle grips.

That which is claimed:

1. In a control apparatus for use with a personal vehicle having forward and reverse and left-right steering capabilities, said control apparatus including a steering assembly providing steering and forward and reverse control by a user situated upon said personal vehicle, said user having left and right hands, said steering assembly comprising:
a frame member;
a handle member rigidly attached to said frame member, said handle member including opposing left and right handle portions configured to allow said user to grip said handle member with the left and right hands, respectively, and to steer said vehicle left and right by manipulation of said handle member;
a pivoting bar member including opposing left and right extending portions, said pivoting bar member being pivotably mounted relative to said frame member, said pivoting bar member positioned and configured to allow said user to rest the palms on the handle portions of said handle member while being able to touch the opposing left and right extending portions of said pivoting bar member with outstretched fingers and to pull either but not both of said left or right extending portions towards their associated left or right handle portions by a hand squeezing action; and
a pair of switches operably associated with said pivoting bar member;
such that pivoting said pivoting bar member in a first direction by a squeezing action of one hand of the user causes said first switch to be activated, and pivoting said pivoting bar in a second direction by a squeezing action of the other hand of said user causes said second switch to be activated.

2. The steering assembly as claimed in claim 1, wherein said first and second switches are commonly oriented.

3. The steering assembly as claimed in claim 2, wherein said switches contact the same side of said pivoting bar member and are depressed by said pivoting bar when activated.

4. The steering assembly as claimed in claim 1, wherein said switches contact the same side of said pivoting bar member and are depressed by said pivoting bar when activated.

5. In a control apparatus for use with a personal vehicle having forward and reverse and left-right steering capabilities, said control apparatus including a steering assembly providing steering and forward and reverse control by a user situated upon said personal vehicle, said user having left and right hands, said steering assembly comprising:
a frame member;
a handle member rigidly attached to said frame member, said handle member being elongate and including opposing left and right handle portions configured to allow said user to grip said handle member with the left and right hands, respectively, and to steer said vehicle left and right by manipulation of said handle member;
an integral pivoting bar member including opposing left and right extending portions, said pivoting bar member being pivotably mounted relative to said frame member about an axis being substantially orthogonal to the longitudinal axis of said elongate handle member, said pivoting bar member positioned and configured to allow said user to rest the palms on the handle portions of said handle member while being able to touch the opposing left and right extending portions of said pivoting bar member with outstretched fingers and to pull either but not both of said left or right extending portions towards their associated left or right handle portions by a hand squeezing action;
a first switch configured to be switched when said pivoting bar member is pivoted in a first direction about said axis; and
a second switch configured to be switched when said pivoting bar member is pivoted in a second direction about said axis;
such that pivoting said pivoting bar member in a first direction by a squeezing action of one hand of the user causes said first switch to be activated, and pivoting said pivoting bar in a second direction by a squeezing action of the other hand of said user causes said second switch to be activated.

6. The steering assembly as claimed in claim 5, wherein said integral pivoting bar member is substantially parallel to said handle member when said integral pivoting bar member is not being pivoted but is in a neutral position.

7. The steering assembly as claimed in claim 5, wherein said first and second switches are commonly oriented.

8. The steering assembly as claimed in claim 7, wherein said switches contact the same side of said pivoting bar member and are depressed by said pivoting bar when activated.

9. The steering assembly as claimed in claim 8, wherein when said pivoting bar member is pivoted in a first direction, said right extending portion of said pivoting bar member moves towards said right handle portion of said handle member, and wherein when said pivoting bar member is pivoted in a second direction, said left extending portion of said pivoting bar member moves towards said left handle portion of said handle member.

10. The steering assembly as claimed in claim 5, wherein said switches contact the same side of said pivoting bar member and are depressed by said pivoting bar when activated.

11. The steering assembly as claimed in claim 10, wherein when said pivoting bar member is pivoted in a first direction, the right extending portion of said pivoting bar member moves towards said right handle portion of said handle member, and wherein when said pivoting bar member is pivoted in a second direction, the left extending portion of said pivoting bar member moves towards said left handle portion of said handle member.

12. A method of operating a control apparatus of a personal vehicle having forward and reverse and left-right steering capabilities, said control apparatus including a steering assembly providing steering and forward and reverse control by a user situated upon said personal vehicle, said user having left and right hands, said method comprising the steps of:
A) providing said steering assembly such that it comprises:
1) a frame member;
2) a handle member rigidly attached to said frame member, said handle member including opposing left and right handle portions configured to allow said user to grip said handle member with the left and right hands, respectively, and to steer said vehicle left and right by manipulation of said handle member;
3) a pivoting bar member including opposing left and right extending portions, said pivoting bar member being pivotably mounted relative to said frame member, said pivoting bar member positioned and configured to allow said user to rest the palms on the handle portions of said handle member while being able to touch the opposing left and right extending portions of said pivoting bar member with outstretched fingers and to pull either but not both of said left or right extending portions towards their associated left or right handle portions by a hand squeezing action; and
4) a pair of switches operably associated with said pivoting bar member; and
B) pivoting said pivoting bar member in a first direction by a squeezing action of one hand of the user such that said first switch is activated and said vehicle moves in a forward direction, and pivoting said pivoting bar in a second direction by a squeezing action of the other hand of said user such that said second switch is activated and said vehicle moves in a second direction.

13. The method as claimed in claim 12, wherein in step “B”, said first direction is forward and said second direction is reverse.

14. A personal vehicle for use by a user, said personal vehicle comprising;
a first, front, frame member supporting at least one wheel;
a first electrical wire including a first electrical connection, said first electrical wire attached relative to said first frame member;
a second, rear, frame member supporting at least one wheel;
a second electrical wire including a second electrical connection configured for selective electrical connection with said first electrical connection, said second electrical wire attached relative to said second frame member; and
a detachable connection between said first and second frame members, said detachable connection including a connected mode and a disconnected mode, such that said personal vehicle may be operated while said detachable connection is in said connected mode and said first and second frame members are attached and said first and second electrical connections are attached, and such that said personal vehicle may be transported while said detachable connection is in said disconnected mode and said first and second frame members are detached and said first and second electrical connections are detached.

15. The personal vehicle as claimed in claim 14, wherein said detachable connection between said first and second frame members is provided by use of a tube and sleeve connection, with a tube extending from one of said first and second frame members, and a sleeve defined by the other of said first and second frame members, said tube configured to fit within said sleeve when said detachable connection is in said connected mode, and said tube configured to be separated from said sleeve when said detachable connection is in said disconnected mode.

16. The personal vehicle as claimed in claim 15, wherein said tube and sleeve are hollow and allow for said electrical connection to be made through their bores.

17. The personal vehicle as claimed in claim 14, wherein said first electrical wire is part of a first wiring harness and said second electrical wire is part of a second wiring harness.

18. The personal vehicle as claimed in claim 14, wherein said personal vehicle further comprises a seat detachably connected to said second, rear, frame member, said seat being detachable when said personal vehicle is transported.

19. The personal vehicle as claimed in claim 14, wherein said personal vehicle further comprises at least one battery detachably connected to said second, rear, frame member, said battery being detachable when said personal vehicle is transported.

20. A personal vehicle for use by a user, said personal vehicle comprising:
a first, front, frame member supporting at least one wheel;
a first electrical wire including a first electrical connection, said first electrical wire attached relative to said first frame member;
a second, rear, frame member supporting at least one wheel;
a second electrical wire including a second electrical connection configured for selective electrical connection with said first electrical connection, said second electrical wire attached relative to said second frame member; and
a detachable yet pivotable connection between said first and second frame members, said detachable yet pivotable connection including a connected mode and a disconnected mode, such that said personal vehicle may be operated while said detachable yet pivotable connection is in said connected mode and said first and second frame members are attached and said first and second electrical connections are attached, and such that said personal vehicle may be transported while said detachable yet pivotable connection is in said disconnected mode and said first and second frame members are detached and said first and second electrical connections are detached.

21. The personal vehicle as claimed in claim 20, wherein said pivoting is about an axis substantially along the front-to-back direction, and said pivoting is limited to a predetermined range.

22. The personal vehicle as claimed in claim 21, wherein said pivoting is provided by the use of a pin extending from one of said first and second frame members and a slotted flange extending from the other of said first and second frame members, said slotted flange defining a slot shaped to accept said pin and to define the range of pivoting allowed.

23. The personal vehicle as claimed in claim 20, wherein said detachable connection between said first and second frame members is provided by use of a tube and sleeve connection, with a tube extending from one of said first and second frame members, and a sleeve defined within the other of said first and second frame members, said tube configured to fit within said sleeve when said detachable connection is in said connected mode, and said tube configured to be out of said sleeve when said detachable connection is in said disconnected mode.

24. A method of operating a vehicle in one mode and transporting said vehicle in a disassembled mode, said method comprising the steps of:
A) providing a personal vehicle configured for being operated or transported, said personal vehicle comprising:
1) a first, front, frame member supporting at least one wheel;
2) a first electrical wire including a first electrical connection, said first electrical wire attached relative to said first frame member;
3) a second, rear, frame member supporting at least one wheel;
4) a second electrical wire including a second electrical connection configured for selective electrical connection with said first electrical connection, said second electrical wire attached relative to said second frame member; and
5) a detachable yet pivotable connection between said first and second frame members, said detachable yet pivotable connection including a connected and a disconnected mode;
B) operating said personal vehicle while said detachable yet pivotable connection is in said connected mode and said first and second frame members are attached and said first and second electrical connections are attached, and
C) transporting said personal while said detachable yet pivotable connection is in said disconnected mode and said first and second frame members are detached and said first and second electrical connections are detached.
